(19) United States
(12) Patent Application Publication
(10) Pub. No.: US 2010/0060129 A1
(43) Pub. Date: Mar. 11, 2010

(54) Spacer and electron emission display having the same

(76) Inventors: Sung-Hwan Jin, Suwon-si (KR); Cheol-Hyeon Chang, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 11/589,766

(22) Filed: Oct. 31, 2006

(30) Foreign Application Priority Data
Oct. 31, 2005 (KR) 10-2005-0103527

(51) Int. Cl. H01J 61/52

(52) U.S. Cl. 313/45

(57) ABSTRACT

A spacer disposed between first and second substrates of an electron emission display is provided. The spacer includes a main body and a heat dissipation layer formed on a side surface of the main body.

### CLAIM OF PRIORITY

This application makes reference to, incorporates the same herein, and claims all benefits accruing under 35 U.S.C. §119 from an application for SPACER AND ELECTRON EMISSION DISPLAY HAVING THE SAME earlier filed in the Korean Intellectual Property Office on 31 Oct. 2005 and there duly assigned Serial No. 10-2005-0103527.

### BACKGROUND OF THE INVENTION

1. Field of the Invention

The present invention relates to a spacer and an electron emission display incorporating the spacer, and more particularly, to a spacer that is designed to prevent electric charges from being accumulated on the surface of the spacer and an electron emission display incorporating the spacer.

2. Description of the Related Art

Generally, electron emission elements are classified as either those using hot cathodes as an electron emission source, or those using cold cathodes as the electron emission source. There are several types of cold cathode electron emission elements, including Field Emitter Array (FEA) elements, Surface Conduction Emitter (SCE) elements, Metal-Insulator-Metal (MIM) elements, and Metal-Insulator-Semiconductor (MIS) elements.

A typical electron emission element is constructed with an electron emission region and driving electrodes for controlling the electron emission of the electron emission region. The electron emission region emits electrons according to the voltage applied to the driving electrodes. A plurality of electron emission elements are aligned on a first substrate to form an electron emission device. The first substrate of the electron emission device is disposed to face a second substrate on which a light emission unit having a phosphor layer and an anode electrode are provided. The first and second substrates are sealed together at their peripheries using a sealing member and the inner space between the first and second substrates is exhausted to form an electron emission display having a vacuum envelope.

In addition, a plurality of spacers are disposed in the vacuum envelope to prevent the substrates from being damaged or broken by a pressure difference between inside and outside of the vacuum envelope.

The spacers are generally made from a nonconductive material such as ceramic or glass and disposed to correspond to non-emission areas between the phosphor layers so as not to interfere with the traveling paths of the electrons emitted from the electron emission device toward the phosphor layers.

When the electrons emitted from the electron emission device travel toward the corresponding phosphor layers, an electron beam-diffusing phenomenon may occur due to a high electric field caused by the anode electrode. The electron beam-diffusing phenomenon cannot be completely suppressed even when a focusing electrode is provided.

Due to the electron beam-diffusing phenomenon, some of the electrons cannot land on the corresponding phosphor layers but instead, collide with the spacers. The spacers made from the glass or ceramic have an electron emission coefficient higher than one. Therefore, when the electrons collide with the spacers, many secondary electrons are emitted from the spacers and thus the spacers are positively charged. When the spacers are charged, the electric field around the spacers undesirably varies to distort the electron beam path.

Furthermore, heat is generated in the vacuum envelope by the electrons emitted from the electron emission device during the operation of the electron emission display. Since the spacers made from glass or ceramic have a relatively low thermal-resistance, an electric property such as voltage resistance of the spacer may be altered. This also causes the variation of the electric field around the spacers to worsen the distortion of the electron beam path.

The electron beam distortion causes the electrons emitted from the electron emission device to move toward the spacers. In this case, the spacers may be readily observed on a screen by the viewer's naked eyes, thereby deteriorating the display quality of the video display device.

### SUMMARY OF THE INVENTION

It is therefore an object of the present invention to provide an improved spacer to be used in an electron emission display.

It is another object of the present invention to provide a spacer that can suppress an electron beam distortion to prevent the display quality from being reduced and an electron emission display incorporating the spacer.

According to an exemplary embodiment of the present invention, a spacer is disposed between first and second substrates of a vacuum envelope, and the spacer is constructed with a main body and a heat dissipation layer formed on a side surface of the main body.

The heat dissipation layer may be made from a material having a thermal conductivity within a range of approximately 0.4 cal/cm·s·° C. to approximately 1 cal/cm·s·° C.

The heat dissipation layer may contain metal.

The spacer may be further constructed with a resistive layer formed between the main body and the heat dissipation layer and a secondary electron emission preventing layer formed on the heat dissipation layer.

According to another exemplary embodiment of the present invention, an electron emission display is constructed with first and second substrates forming a vacuum envelope, an electron emission unit provided on the first substrate, a light emission unit provided on the second substrate, and a spacer disposed between the first and second substrates. The spacer may be constructed with a main body and a heat dissipation layer formed on a side surface of the main body.

The heat dissipation layer may be made from a material selected from the group of Au, Ag, Cu, and Al.

The electron emission display may be further comprised of a contact electrode layer formed on the bottom surface of the spacer and an insulation layer formed on the top surface of the spacer.

The electron emission unit may include an electron emission region and a plurality of electrodes for driving the electron emission region.

The electron emission regions may be made from a material selected from the group of carbon nanotubes, graphite, graphite nanofibers, diamonds, diamond-like carbon, fullerene (C₆₀), silicon nanowires, and a combination of these materials.

The electron emission display may be further constructed with a focusing electrode disposed between the first and second substrate.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partially exploded perspective cross-sectional view of an electron emission display constructed as an embodiment according to the principles of the present invention;

FIG. 2 is a partial cross-sectional view of the electron emission display of FIG. 1; and

FIG. 3 is a partial cross-sectional view of an electron emission display constructed as another embodiment according to the principles of the present invention.

### DETAILED DESCRIPTION OF INVENTION

The present invention will now be described more fully with reference to the accompanying drawings, in which exemplary embodiments of the invention are shown. The invention may, however, be embodied in many different forms and should not be construed as being limited to the embodiments set forth herein; rather these embodiments are provided so that this disclosure will be thorough and complete, and will fully convey the concept of the invention to those skilled in the art.

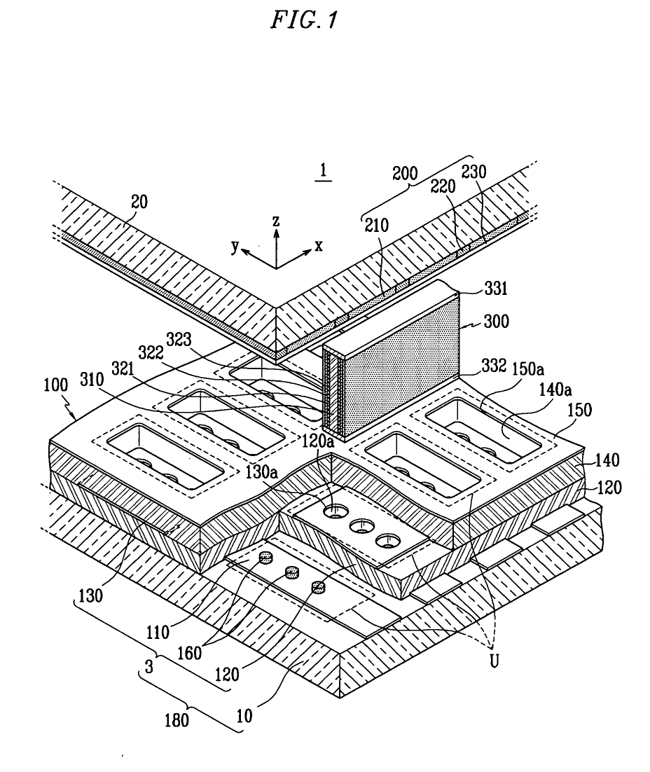

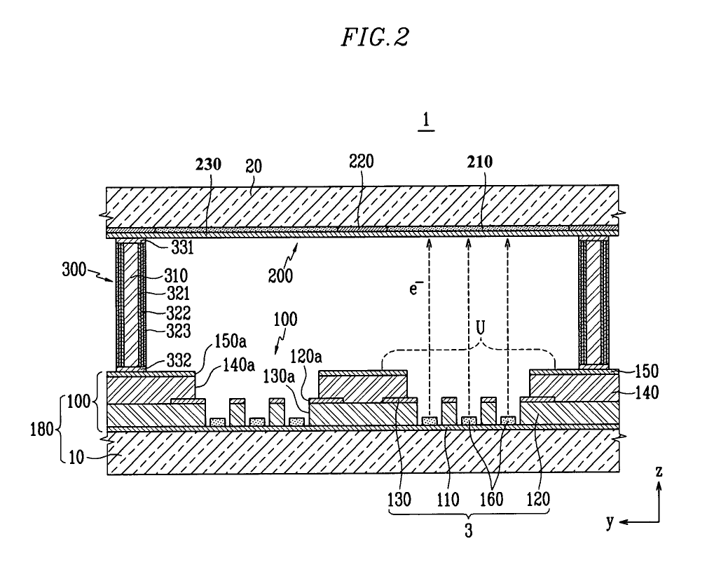

FIGS. 1 and 2 show an electron emission display constructed as an embodiment according to the principles of the present invention. In this embodiment, an electron emission display having an array of field emitter array (FEA) elements is illustrated.

Referring to FIGS. 1 and 2, an electron emission display 1 is constructed with first and second substrates 10 and 20 facing each other at a interval. A sealing member (not shown) is provided around the peripheries of first and second substrates 10 and 20 to seal them together. The space defined by first and second substrates 10 and 20 and the sealing member is exhausted to form a vacuum envelope.

Electron emission unit 100 for emitting electrons and light emission unit 200 for emitting visible light using the electrons emitted from electron emission unit 100 are respectively provided on the facing surfaces of first and second substrates 10 and 20.

That is, a plurality of cathode electrodes (first electrodes) 110 are arranged on first substrate 10 in a stripe pattern extending in a direction (a direction of the y-axis in FIG. 1) and a first insulation layer 120 is formed on first substrate 10 to cover cathode electrodes 110. A plurality of gate electrodes (second electrodes) 130 are formed on first insulation layer 120 in a stripe pattern extending in a direction (a direction of the x-axis in FIG. 1) to cross cathode electrodes 110 at right angles.

One or more electron emission regions 160 are formed on cathode electrode 6 at each crossed region of gate and cathode electrodes 110 and 130. Openings 120a and 130a corresponding to electron emission regions 160 are formed in first insulation layer 120 and gate electrodes 130 to expose electron emission regions 160.

Electron emission regions 160 may be made from a material, which emits electrons when an electric field is applied to electron emission regions 160 under a vacuum atmosphere, such as a carbonaceous material or a nanometer-sized material. For example, electron emission regions 160 may be made from carbon nanotubes, graphite, graphite nanofibers, diamonds, diamond-like carbon, fullerene (C₆₀), silicon nanowires, or a combination of these materials through a screen-printing, direct growth, chemical vapor deposition, or sputtering process.

In FIG. 1, three electron emission regions 160 are arranged in series along cathode electrodes 110 at each crossed region (hereinafter, referred as “unit pixel area U”) and each of electron emission regions 160 have a flat, circular top surface. The arrangement and top surface shape of electron emission regions 160 are, however, not limited to the foregoing embodiment.

In the foregoing description, although a case where gate electrodes 130 are arranged above cathode electrodes 110 with first insulation layer 120 interposed therebetween is described as an example, the present invention is not limited to this case. That is, the gate electrodes may be disposed under the cathode electrodes with the first insulation layer interposed therebetween. In this case, the electron emission regions may be formed on the sidewalls of the cathode electrodes on the first insulation layer.

One cathode electrode 110, one gate electrode 130, first insulation layer 120, and three electron emission regions 160 integrally form one electron emission element 3. A plurality of electron emission elements 3 is arrayed on first substrate 10 to form an electron emission device 180.

In addition, a second insulation layer 140 is formed on the first insulation layer 120 while covering ate electrodes 130 and a focusing electrode 150 is formed on second insulation layer 140. Openings 140a and 150a through which electron beams pass are formed in second insulation layer 140 and focusing electrode 150. Openings 140a and 150a are formed to correspond to one electron emission element 3 to generally focus the electrons emitted from electron emission regions 150 at each electron emission element 3. At this point, the greater the voltage difference between focusing electrode 150 and electron emission regions 160, the higher the focusing efficiency. Therefore, it is preferable that the thickness of second insulation layer 140 be greater than that of first insulation layer 120.

In addition, focusing electrode 150 may be formed on an entire surface of second insulation layer 140 or may be formed in a pattern having a plurality of sections corresponding to unit pixel regions U.

Focusing electrode 150 may be made from a conductive layer deposited on second insulation layer 140 or a metal plate having openings 150a.

Phosphor layers 210 and a black layer 220 are formed on a surface of second substrate 20 facing first substrate 10. An anode electrode 230 made from a conductive material such as aluminum is formed on phosphor and black layers 210 and 220. FIG. 1 illustrates this case. Anode electrode 230 functions to heighten the screen luminance by receiving a high voltage required for accelerating the electron beams and reflecting the visible rays, which is radiated from phosphor layers 210 to first substrate 10, toward second substrate 20.

Alternatively, anode electrode 230 can be made from a transparent conductive material, such as Indium Tin Oxide (ITO), instead of the metallic material. In this case, anode electrode 230 is placed on second substrate 20 and phosphor and black layers 210 and 220 are formed in a pattern on anode electrode 230. Alternatively, anode electrode 230 may be formed in a pattern corresponding to the pattern of phosphor and black layers 210 and 220.

Alternatively, anode electrode 230 made from both of a transparent material and a metal layer in order to enhance the luminance can be formed on second substrate 20.

Phosphor layers 210 may be arranged to correspond to unit pixel areas U defined on first substrate 10. Alternatively, phosphor layers 210 may be arranged in a pattern extending along the y-axis of FIG. 1. Black layer 220 may be made from a non-transparent material such as chrome or chromic oxide.

In the above-described electron emission display 1, phosphor layers 210 are formed to correspond to the respective electron emission elements 3. At this point, one phosphor layer 210 and one electron emission element 3 that correspond to each other define one pixel of electron emission display 1.

Disposed between first and second substrates 10 and 20 are spacers 300 (only one is shown) for uniformly maintaining a gap between first and second substrates 10 and 20. Spacers 300 are arranged at a non-emission area over which black layer 220 is disposed. In this embodiment, a wall-type spacer is exampled.

Spacer 300 is constructed with a main body 310 made from a non-electrically conductive material such as glass or ceramic, a resistive layer 321 covering side surfaces of main body 310, a heat dissipation layer 322 formed on resistive layer 321, and a second electron emission preventing layer 323 formed on heat dissipation layer 322.

Resistive layer 321 provides a traveling path for the electric charges to prevent the electric charges from being accumulated on spacer 300. Resistive layer 321 is made from a high resistive material having a relatively weak electrical conduction property. For example, the high resistive material contains metal selected from the group of Pt, W, Ti, Cr and an alloy of these metals, and a compound selected from the group of AlN, GeN, Al₂O₃, and a combination of these compounds. Preferably, the high resistive material may be made from one of Pt/AlN, Ti/Al₂O₃, and Cr/AlN.

Heat dissipation layer 322 dissipates the heat which is generated in the vacuum envelope by the electrons, out of the vacuum envelope through first and second substrates 10 and 20, to prevent the heat from being transmitted to main body 310 of spacer 300, thereby preventing the variation of the electric property of spacer 300. Heat dissipation layer 322 may be made from a material having a thermal conductivity within a range of approximately 0.4 cal/cm·s·° C. to approximately 1 cal/cm·s·° C. For example, heat dissipation layer 322 may be made from a low resistive material containing Au (0.74 cal/cm·s·° C.), Ag (0.99 cal/cm·s·° C.), Cu (0.94 cal/cm·s·° C.), or Al (0.49 cal/cm·s·° C.). Thermal conductivity is defined as a quantity of heat, transmitted in a time through a thickness, in a direction normal to a surface area due to a temperature difference, and thermal conductivity can be expressed as:

thermal conductivity=heat flow rate×distance/(area×temperature difference).

Secondary electron emission preventing layer 323 minimizes the emission of the secondary electrons from spacer 300 when the electrons collide with spacer 300. Secondary electron emission preventing layer 323 may be made from a material having a secondary electron emission coefficient of one, such as diamond-like carbon or Cr₂O₃.

An insulation layer 331 and a contact electrode layer 332 may be further formed respectively on the top and bottom surfaces of spacer 300. Contact electrode layer 332 may be made from Cr, Ni, or Mo.

In this case, since a negative voltage is applied to focusing electrode 150, the negative voltage is applied to spacer 300. Therefore, the electrons emitted from the electron emission regions 160 having the negative voltage are pushed in the opposite direction of the spacer 300. As a result, the electrons do not collide with spacer 300. Alternatively, the insulation layer and the contact electrode layer may be respectively formed on the bottom and top surfaces of spacer 300. In this case, spacer 300 is electrically connected to anode electrode 230 via the contact electrode layer, and the electrons accumulated on spacer 300 may be moved to an external side.

In addition, spacer 300 may be formed in a cylinder-type having a circular cross section in addition to the wall-type.

The above-described electron emission display is driven when a voltage is applied to cathode, gate, focusing, and anode electrodes 110, 130, 150, and 230.

For example, one of cathode and gate electrodes 110 and 130 may function as a scan electrode receiving a scan driving voltage and the other may function as a data electrode receiving a data driving voltage. Focusing electrode 150 receives a negative voltage of several to tens volts. Anode electrode 230 receives a voltage of, for example, hundreds through thousands volts.

Electric fields are formed around the electron emission regions where a voltage difference between cathode and gate electrodes 110 and 130 is equal to or higher than a threshold value and thus the electrons are emitted from the electron emission regions. The emitted electrons are focused while passing through openings 150a of focusing electrode 150 and strike the corresponding phosphor layers 210 by the high voltage applied to anode electrode 230, thereby exciting phosphor layers 210.

During the above process, the electron beam-diffusing phenomenon occurs despite the operation of focusing electrode 150. Therefore, some of the electrons cannot land on corresponding phosphor layer 210 but instead, collide with spacer 300. At this point, even when the electrons collide with spacer 300, the secondary electron emission from spacer 300 can be minimized by secondary electron emission preventing layer 323. In addition, even when the surface of spacer 300 is charged with electric charges, the electric charges move to the external side of spacer 300 via resistive layer 321 and contact electrode layer and thus the electric charges are not accumulated on the surface of spacer 300. On the other hand, when the negative voltage is applied to spacer 300 from focusing electrode 150, the electrons emitted from electron emission regions 160 are pushed in the opposite direction of spacer 300, and accordingly, the electrons do not collide with spacer 300.

Furthermore, even when the heat is generated in the vacuum envelope by the electrons emitted from electron emission regions 160, the heat transfer to main body 310 of spacer 300 can be prevented by heat dissipation layer 322 and thus the electric property variation of spacer 300 can be prevented.

As a result, in electron emission display 1, the electron beam distortion caused by the electric field distortion around spacer 300 can be prevented.

Although the electron emission display having the FEA elements is described in the above exemplary embodiments, the present invention is not limited to this example. That is, the present invention may be applied to an electron emission display having other types of electron emission elements such as SCE elements, MIM elements and MIS elements.

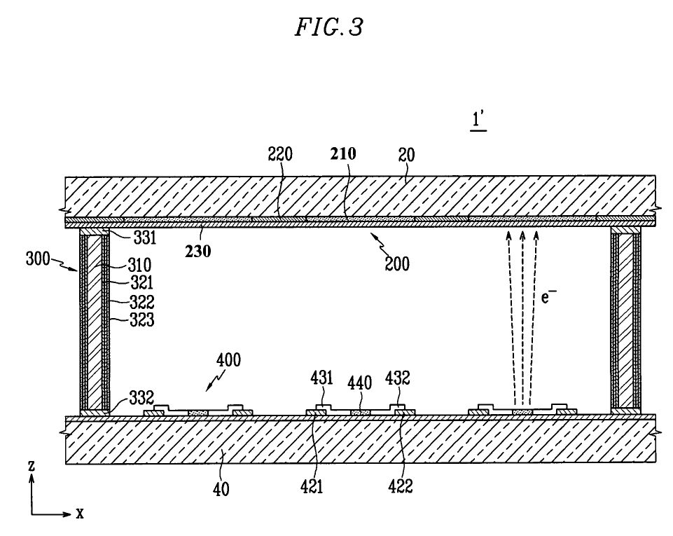

FIG. 3 shows an electron emission display having an array of SCE elements, constructed as another embodiment according to the principles of the present invention. In this embodiment, the parts, that are the same as those of the foregoing embodiment, are assigned with like reference numerals and the detailed description thereof will be omitted herein.

Referring to FIG. 3, first and second substrates 40 and 20 face each other and are spaced apart from each other. An electron emission unit 400 is provided on first substrate 40 while a light emission unit 200 is provided on second substrate 20.

First and second electrodes 421 and 422 are arranged on first substrate 40 and spaced apart from each other. Electron emission regions 440 are formed between the first and second electrodes 421 and 422. First and second conductive layers 431 and 432 are respectively formed on first substrate 40 between first electrode 421 and electron emission region 440 and between electron emission region 440 and second electrode 422 while partly covering first and second electrodes 421 and 422. That is, first and second electrodes 421 and 422 are electrically connected to electron emission region 440 by first and second conductive layers 421 and 422, respectively.

In this embodiment, first and second electrodes 421 and 422 may be made from a variety of conductive materials. First and second conductive layers 431 and 432 may be particle thin film made from a conductive material such as Ni, Au, Pt, or Pd. Electron emission regions 440 may be made from graphite carbon or carbon compound. For example, electron emission regions 440 may be made from a material selected from the group of carbon nanotubes, graphite, graphite nanofibers, diamonds, diamond-like carbon, fullerene (C₆₀), silicon nanowires, or a combination of these materials.

When voltages are applied to first and second electrode 421 and 422, current flows in a direction in parallel with surfaces of electron emission regions 440 through first and second conductive layers 431 and 432, thereby realizing surface-conduction electron-emission. The emitted electrons strike and excite corresponding phosphor layers 210 by being attracted by the high voltage applied to anode electrode 230.

According to the principles of the present invention, since the spacer is constructed with the resistive layer, the secondary electron emission preventing layer, the contact electrode layer, and the insulation layer the electric field distortion around the spacer can be prevented and thus the electron beam distortion can be prevented.

Furthermore, since the spacer further includes the heat dissipation layer formed between the resistive layer and the secondary electron emission preventing layer, the heat generated during the operation of the electron emission display can be dissipated and thus the electric property variation of the spacer can be prevented, thereby preventing the electric field distortion.

As a result, the spacer is not observed on the screen by naked eyes and thus the display quality of the electron emission display can be improved.

Although exemplary embodiments of the present invention have been described in detail hereinabove, it should be clearly understood that many variations and/or modifications of the basic inventive concept taught herein still fall within the spirit and scope of the present invention, as defined by the appended claims.

1. A spacer disposed between first and second substrates of a vacuum envelope, said spacer comprising:
a main body; and
a heat dissipation layer formed on a side surface of the main body, with the heat dissipation layer being formed on an entirety of the side surface of the main body, and said side surface being not covered by the first and second substrates.

2. The spacer of claim 1, comprised of the heat dissipation layer being made from a material having a thermal conductivity within a range of approximately 0.4 cal/cm·s·° C. to approximately 1 cal/cm·s·° C.

3. The spacer of claim 2, comprised of the heat dissipation layer comprising metal.

4. The spacer of claim 2, comprised of the heat dissipation layer being made from Au, Ag, Cu or Al.

5. The spacer of claim 1, further comprising a resistive layer formed between the main body and the heat dissipation layer.

6. The spacer of claim 1, further comprising a secondary electron emission preventing layer formed on the heat dissipation layer.

7. The spacer of claim 1, further comprising:
a resistive layer formed between the main body and the heat dissipation layer; and
a secondary electron emission preventing layer formed on the heat dissipation layer.

8. The spacer of claim 7, comprised of the resistive layer being made from a metal selected from the group consisting essentially of Pt, W, Ti, Cr and an alloy of these metals, and a compound selected from the group of AlN, GeN, Al₂O₃, and a combination of these compounds.

9. The spacer of claim 7, comprised of the resistive layer being made from one of Pt/AlN, Ti/Al₂O₃, and Cr/AlN.

10. The spacer of claim 7, comprised of the secondary electron emission preventing layer being made from diamond-like carbon or Cr₂O₃.

11. The spacer of claim 1, comprised of the main body being made from glass or ceramic.

12. The spacer of claim 1, further comprising a contact electrode layer formed on the bottom surface of the spacer and an insulation layer formed on the top surface of the spacer.

13. The spacer of claim 12, comprised of the contact electrode layer being made from Cr, Ni or Mo.

14. An electron emission display, comprising:
first and second substrates forming a vacuum envelope;
an electron emission unit provided on the first substrate;
a light emission unit provided on the second substrate; and
a spacer disposed between the first and second substrates, with said spacer comprising a main body and a heat dissipation layer formed on a side surface of the main body, the heat dissipation layer being formed on an entirety of the entire side surface of the main body.

15. The electron emission display of claim 14, with the heat dissipation layer being made from a material having a thermal conductivity within a range of approximately 0.4 cal/cm·s·° C. to approximately 1 cal/cm·s·° C.

16. The electron emission display of claim 15, comprised of the heat dissipation layer comprising metal.

17. The electron emission display of claim 16, comprised of the heat dissipation layer being made from a material selected from the group consisting essentially of Au, Ag, Cu, and Al.

18. The electron emission display of claim 14, comprised of the spacer further comprising:
a resistive layer formed between the main body and the heat dissipation layer; and
a secondary electron emission preventing layer formed on the heat dissipation layer.

19. The electron emission display of claim 14, further comprising a contact electrode layer formed on the bottom surface of the spacer and an insulation layer formed on the top surface of the spacer.

20. The electron emission display of claim 14, comprised of the electron emission unit comprising an electron emission region and a plurality of electrodes for driving the electron emission region.

21. The electron emission display of claim 20, comprised of the electron emission regions being made from a material selected from the group consisting of carbon nanotubes, graphite, graphite nanofibers, diamonds, diamond-like carbon, fullerene (C₆₀), silicon nanowires, and a combination thereof.

22. The electron emission display of claim 14, further comprising a focusing electrode disposed between the first and second substrate.

23. A spacer disposed between first and second substrates of a vacuum envelope, comprising:
a main body; and
a heat dissipation layer formed on an entirety of a major side surface of the main body, with the major side surface having a larger surface area than other side surfaces of the main body.
